(19) United States
(12) Patent Application Publication
(10) Pub. No.: US 2025/0224624 A1
(43) Pub. Date: Jul. 10, 2025

(54) HYPEREXTENDABLE FRICTION HINGE

(71) Applicant: Snap Inc., Santa Monica, CA (US)

(72) Inventors: Chao Chen, Marina Del Rey, CA (US); Stoyan Hristov, Gilroy, CA (US); Anthony David Mare, San Francisco, CA (US)

(21) Appl. No.: 19/009,549

(22) Filed: Jan. 3, 2025

Related U.S. Application Data
(60) Provisional application No. 63/618,130, filed on Jan. 5, 2024.

(51) Int. Cl. G02C 5/22; G02B 27/01; G09G 3/00

(52) U.S. Cl. CPC G02C 5/2218; G02B 27/0176; G02B 2027/0178; G09G 3/001

(57) ABSTRACT

A example hinge apparatus comprises a first hinge member and a second hinge member rotatably coupled together to form a rotation range between them. A hyperextension mechanism exerts a hyperextension clamping force when the members over-rotate outside the rotation range into a hyperextension zone. The hyperextension mechanism may comprise a cantilevered or clip structure providing the clamping force. A friction component can provide rotational resistance between the members during normal rotation, with less resistive torque than the hyperextension mechanism. Structural aspects include a part cylindrical shell structure dividing or enclosing compartments in the apparatus and allowing passage of an electrical FPC connection. Installation portions like pins, holes, and alignments mount the apparatus. The variable hyperextension clamping force protects sensitive augmented reality glasses components from damage during managed hyperextension, while also accommodating extended range of fit. Lightweight construction minimizes mass contribution. The hinge apparatus integrates smoothly into AR glasses, avoiding discomfort that could impair immersive experiences.

### CLAIM OF PRIORITY

This patent application claims the benefit of priority to Chao et al, U.S. Provisional Patent Application Ser. No. 63/618,130, entitled “HYPEREXTENDABLE FRICTION HINGE,” filed on Jan. 5, 2024, which is hereby incorporated by reference herein in its entirety.

### BACKGROUND

Augmented reality (AR) glasses typically comprise a frame, temples, and optical components that enable a wearer to view augmented content. The frame houses the optical components, such as waveguides and projectors, that merge virtual images with the wearer's real-world view. The temples connect to the frame via hinges and extend rearward to rest on the wearer's ears to support the glasses.

Unmanaged hyperextension of the temples can negatively impact viewing of augmented content. For example, if the temples over-rotate beyond their intended range of motion, the frame and optics may become misaligned or deformed. This could alter the axis along which projected light travels through the waveguides. Any deformation may put the waveguides and projectors out of calibration, causing distortion or other issues with the augmented images.

Additionally, conventional AR glasses are designed for users with average head sizes. Those with larger or smaller heads may experience poor fit leading to discomfort. Typical rigid frames and temples lack adjustability to accommodate different users. Temples may be prone to hyperextension when stretched too far around a large head or may not reach a user's ears when too small.

Therefore, uncontrolled hyperextension can directly reduce optical performance of AR glasses.

### SUMMARY

The present disclosure relates to a hinge apparatus with rotational and hyperextension functionality. The hinge apparatus comprises a first hinge member and a second hinge member rotatably coupled together to allow a rotation zone between them. A hyperextension mechanism is configured to exert a hyperextension clamping force between the first and second hinge members when they are over rotated into a hyperextension zone beyond normal rotation. This protects the hinge from damage, while allowing a managed hyperextension to address some of the problems discussed above. The hyperextension mechanism is engaged upon over rotation between the members.

In one example, the hyperextension mechanism comprises a cantilevered or clip structure such as a binder clip, bulldog clip, U-shape, or C-shape. The cantilever or clip structure conveniently provides the hyperextension clamping force functionality.

Additionally, in some examples, the hinge may comprise a friction component to provide rotational resistance between the two hinge members during normal rotation. In some examples, the friction component may provide less resistive torque than a clamping force or torque generated by the hyperextension mechanism so that the hyperextension mechanism is inactive during normal rotation of the first and second hinge members, and only engaged when the first and second hinge members are over rotated outside a normal rotation zone or range.

Structural aspects include a part cylindrical shell structure to seal, enclose, or divide compartments in the hinge apparatus. Installation portions like pins, holes, and alignments are also provided for mounting the hinge apparatus to augmented reality glasses.

### BRIEF DESCRIPTION OF THE DRAWINGS

FIG. 1 illustrates an example electronic device in accordance with certain examples.

FIG. 2A-FIG. 2B are pictorial views of a hinge apparatus in accordance with certain examples.

FIG. 3A-FIG. 3D are pictorial views of a first hinge member and a second hinge member of a hinge apparatus in accordance with certain examples.

FIG. 4-FIG. 5 are pictorial views of a hinge apparatus in accordance with certain examples.

FIG. 6A-FIG. 6C illustrate aspects of a hinge apparatus for accommodating a flex in accordance with certain example.

FIG. 7A-FIG. 7B are pictorial views of the hinge apparatus of FIG. 6A-FIG. 6C installed on a support arm 202 of example AR glasses in accordance with certain example.

FIG. 8 illustrates a flowchart of example operations in a method in accordance with certain examples.

### DETAILED DESCRIPTION

Some examples herein provide a hinge apparatus for AR glasses that allows comfortable rotation yet provides controlled hyperextension to minimize frame and optic deformation and protect sensitive display optics against over rotation damage. The hinge apparatus can adapt to varying head sizes while restricting temple or arm rotation within safe boundaries. These improvements can help to sustain unimpaired augmented reality experiences.

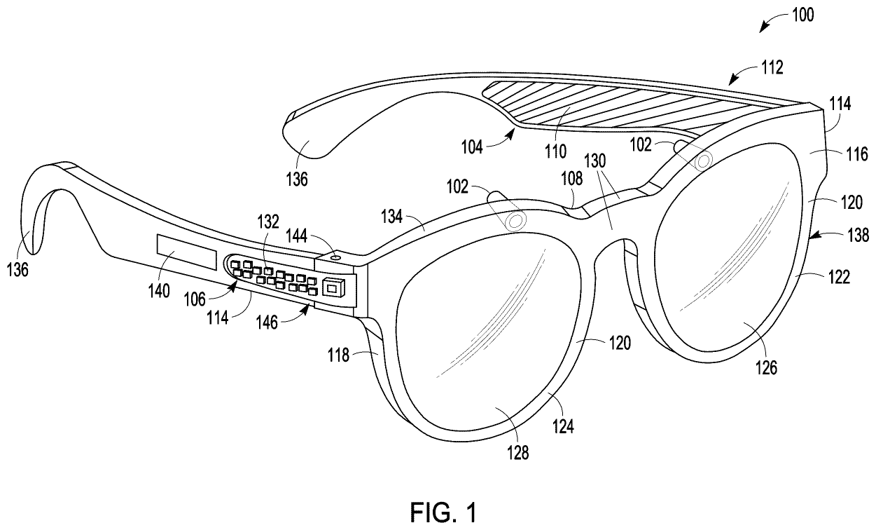

FIG. 1 shows a perspective view of a head-wearable user device, in this example shown as an Augmented Reality (AR) glasses (e.g., the AR glasses 100), in accordance with some examples. The form factor of the AR glasses 100 is compact and space available for internal componentry is tight. The AR glasses 100, in this instance, can be worn to view augmented or virtual content displayed over real content visible in a content interaction system.

The example AR glasses 100 of FIG. 1 include a small frame 112 made from any suitable material such as plastic or metal, including any suitable shape memory alloy, as is well known for ophthalmic eyewear. In one or more examples, the frame 112 includes a front piece 138, including a first or left (as worn by a user) optical element holder 122 (e.g., a display or lens holder) and a second or right (as worn by a user) optical element holder 124, connected by a nose piece or bridge 130. The front piece 138 additionally includes a left end portion 116 and a right end portion 118. A first or left optical element 126 and a second or right optical element 128 can be provided within respective left optical element holder 122 and right optical element holder 124. Each of the right optical elements 128 and the left optical elements 126 can be a lens, a display, a display assembly, or a combination of the foregoing. Any of the display assemblies disclosed herein can be provided in the AR glasses 100.

The frame 112 additionally includes a left arm or temple piece 104 and a right arm or temple piece 106 coupled to the respective left end portion 116 and the right end portion 118 of the front piece 138 by any suitable means such as at a folding hinge 144 (one folding hinge 144 on each side), so as to be coupled to the front piece 138, or rigidly or otherwise secured to the front piece 138 so as to be integral with the front piece 138. In one or more implementations, each of the temple pieces 104 and the temple pieces 106 includes a first portion 114 that is coupled to the respective left end portion 116 or right end portion 118 of the front piece 138 and any suitable second portion 136 for coupling to the car of the user. In some examples, the front piece 138 can be formed from a single piece of material, so as to have a unitary or integral construction. In some examples, such as illustrated in FIG. 1, the entire frame 112 can be formed from a single piece of material so as to have a unitary or integral construction.

As mentioned further above, AR glasses in general also comprise optical components housed within the frame and temples that enable a wearer to view augmented content. The frame houses the optical components, such as waveguides and projectors, that merge virtual images with the wearer's real-world view. The temples connect to the frame at hinges and extend rearward to rest on the wearer's ears to support the glasses. Unmanaged hyperextension of the temples can negatively impact viewing of augmented content. For example, if the temples over-rotate beyond their intended range of motion, the frame and optics may become misaligned or deformed. This could alter the axis along which projected light travels through the waveguides. Any deformation puts the waveguides and projectors out of calibration, causing distortion or other issues with the augmented images.

Additionally, conventional AR glasses are designed for users with average head sizes. Those with larger or smaller heads may experience poor fit leading to discomfort. Typical rigid frames and temples lack adjustability to accommodate different users. Temples may be prone to hyperextension when stretched too far around a large head or may not reach a user's ears when too small. Therefore, uncontrolled hyperextension can directly reduce optical performance of AR glasses. These and other aspects are now described with reference to some specific examples.

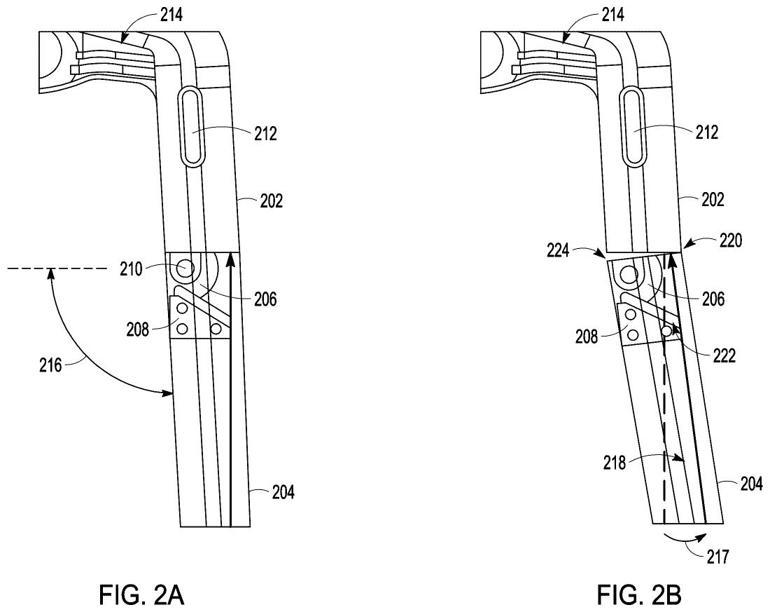

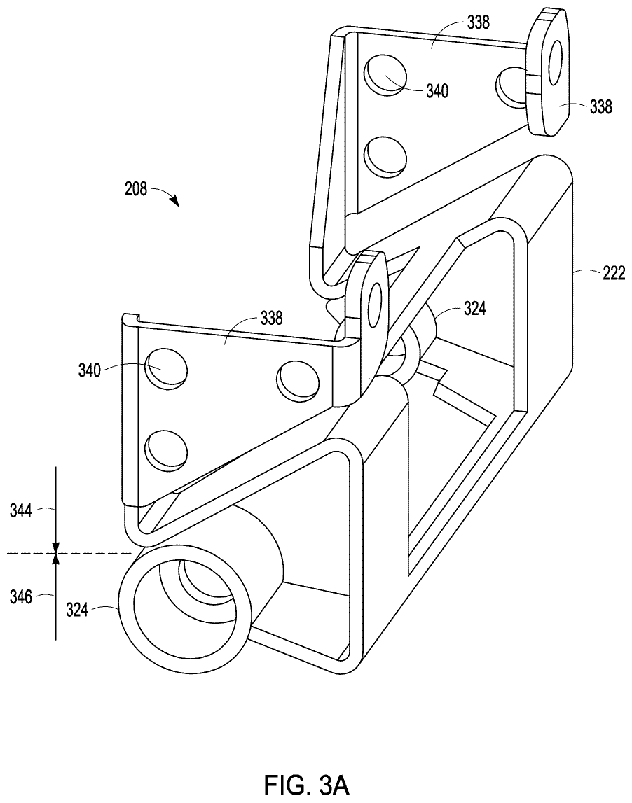

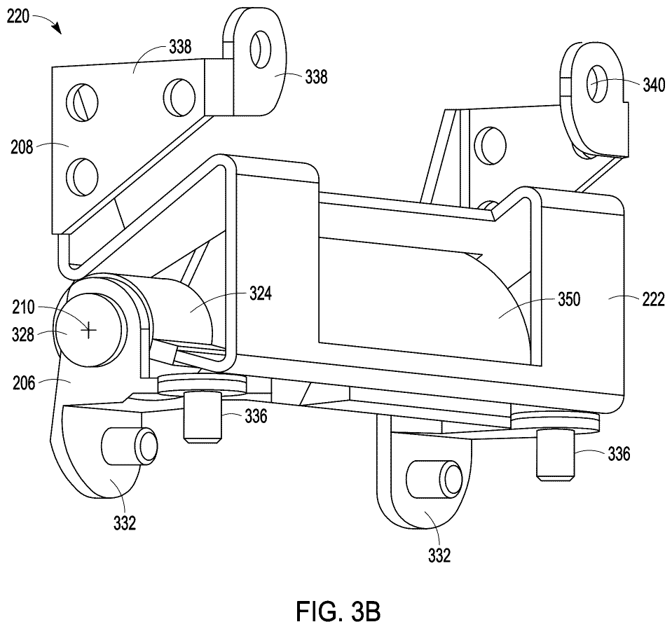

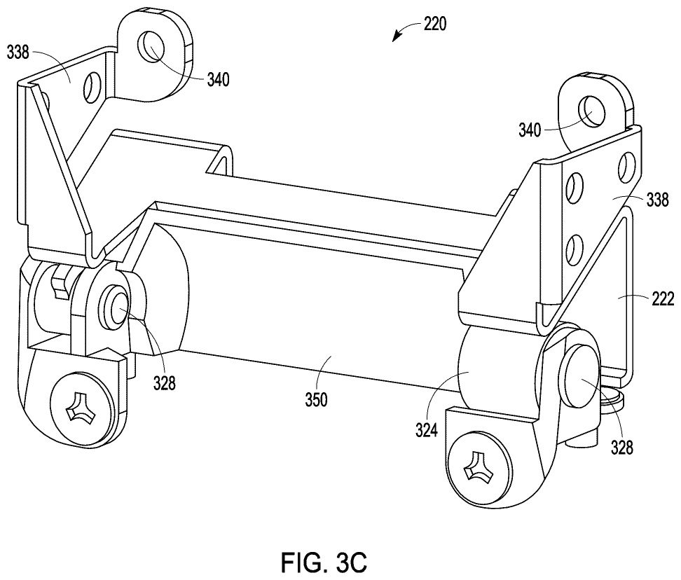

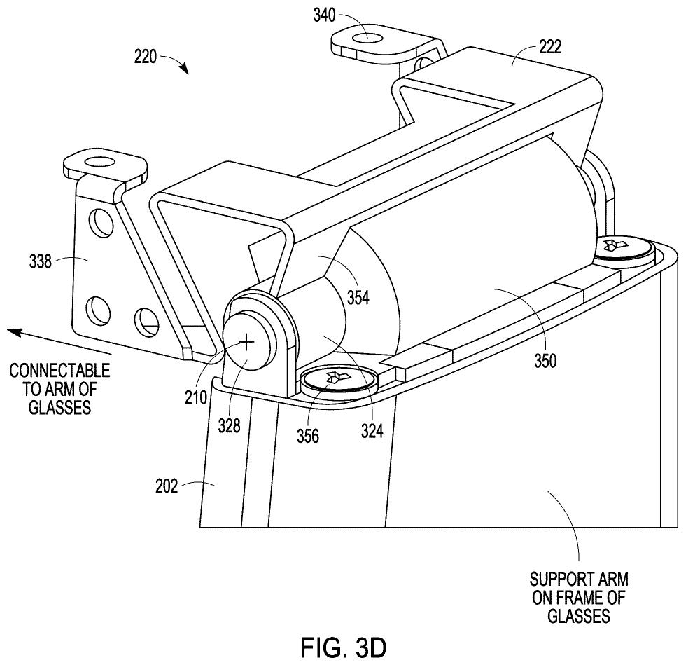

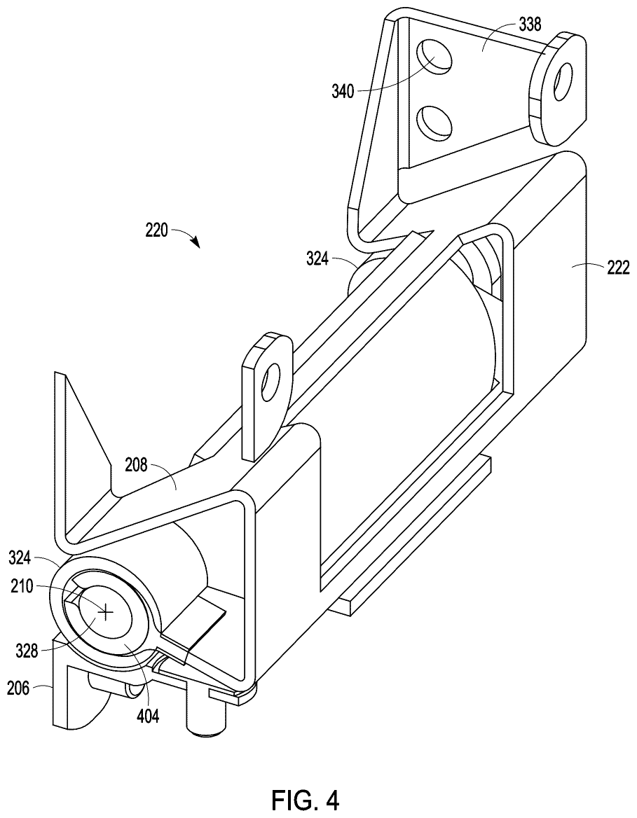

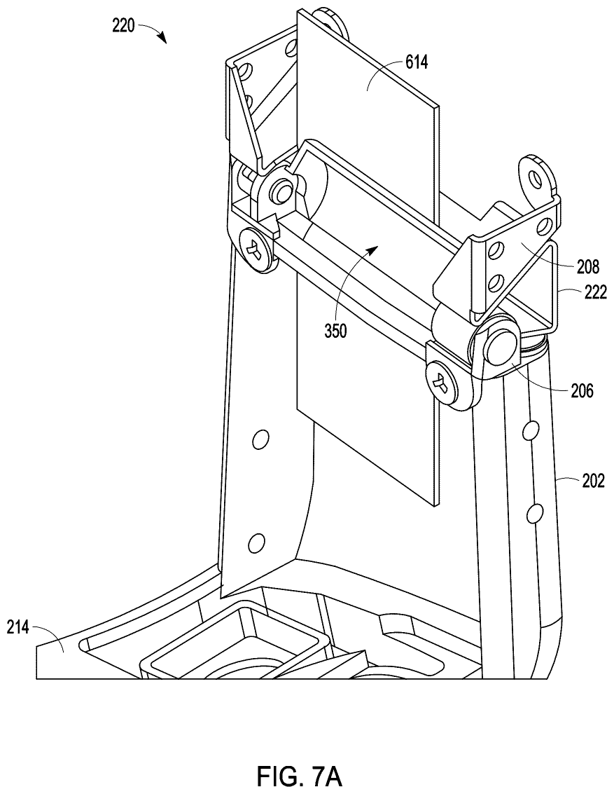

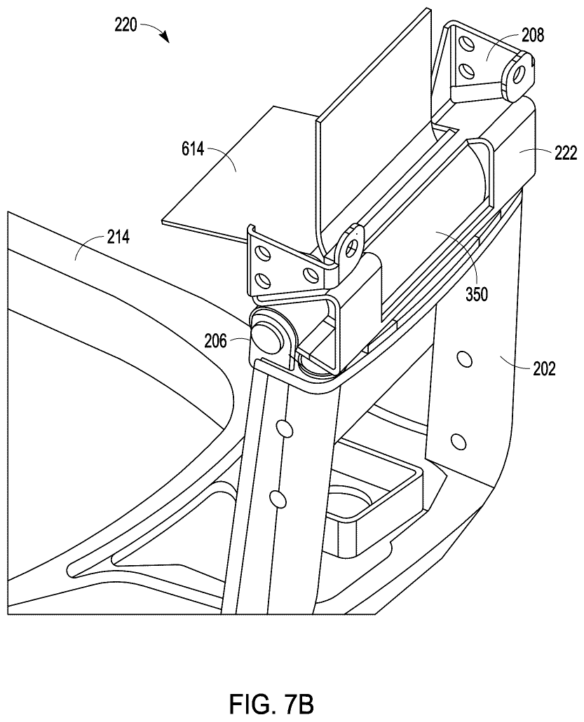

With reference to FIG. 2A-FIG. 2B, an example hinge apparatus 220 is provided with rotational and hyperextension functionality. The hinge apparatus 220 can be installed between a support arm 202 and a right arm 204 of the AR glasses 100, for example as shown in FIG. 3D, and FIGS. 7A-7B. In some examples, this location is at or adjacent the folding hinge 144 of the AR glasses 100 of FIG. 1, but installation on other glasses such as standard reading glasses or sunglasses is possible, for example. The support arm 202 may be provided as an integral extension of a frame 214 for example, but may be separately attached to the frame 214 in other examples. The frame 214 may include one or more features of the frame 112 of FIG. 1 as described herein. The support arm 202 may carry a navigation button 212 for a user to navigate through augmented content viewed in the AR glasses 100, or control one or more components of the AR glasses 100 described further below.

The hinge apparatus 220 comprises a first hinge member 206 and a second hinge member 208 rotatably coupled together at an arm rotation axis 210 to allow a rotation zone between them. The arm rotation axis 210 may coincide with the folding hinge 144 of the AR glasses 100 of FIG. 1 in some examples. These elements can be seen more clearly and in enlarged view in subsequent figures. An example arm rotation zone 216 of approximately 90 degrees of rotation is shown, but other rotations zones are possible. The arm rotation zone 216 may correspond to an opening or closing movement of the arms of the AR glasses 100, for example.

As described in more detail below, a hyperextension element or mechanism 222 is configured to exert a hyperextension clamping force between the first hinge member 206 and the second hinge member 208 when they are over rotated at 217 into a hyperextension zone 218 beyond normal rotation. A visible hyperextension gap, for example at 224 of FIG. 2B, may be created between an end of the right arm 204 and an opposing end of the support arm 202. The hyperextension ability of the hyperextension mechanism 222 protects the hinge apparatus 220 from damage, while allowing a managed hyperextension to address some of the potential optical distortion problems discussed further above. The hyperextension mechanism 222 is engaged upon an over rotation between the hinge members and in some examples is configured to exert a hyperextension clamping force between the first hinge member 206 and the second hinge member 208 when the first and second hinge members are over rotated with respect to one another into the hyperextension zone 218. The hyperextension clamping force is described further below.

Returning again to FIG. 1, the AR glasses 100 include a computing device, such as a computer 132, which can be of any suitable type so as to be carried by the frame 112 and, in one or more examples of a suitable size and shape, so as to be at least partially disposed in one of the temple pieces 104 and the temple pieces 106. In one or more examples, as illustrated in FIG. 1, the computer 132 is sized and shaped similar to the size and shape of one of the temple pieces 106 (e.g., or the temple piece 104), and is thus disposed almost entirely, if not entirely, within the structure and confines of such temple piece 106. In one or more examples, the computer 132 is disposed in both of the temple piece 104 and the temple piece 106 and flexible circuits connecting the two parts of the computer 132 pass through one (or typically both) of the folding hinges 144. The computer 132 can include one or more printed circuit boards (PCBs) and one or more hardware processors with memory, wireless communication circuitry, and a power source. In some examples, the computer 132 comprises low-power circuitry, high-speed circuitry, and a display processor. Various other examples may include these elements in different configurations or integrated together in different ways.

The computer 132 additionally includes a battery 110 or other suitable portable power supply. In some examples, the battery 110 is disposed in one of the temple pieces 104 or the temple piece 106. In the AR glasses 100 shown in FIG. 1, the battery 110 is shown as being disposed in left temple piece 104 and electrically coupled using the connection 134 to the remainder of the computer 132 disposed in the right temple piece 106. The AR glasses 100 can include a connector or port (not shown) suitable for charging the battery 110 accessible from the outside of frame 112, a wireless receiver, transmitter, or transceiver (not shown) or a combination of such devices.

In one or more implementations, the AR glasses 100 include cameras 102. Although two cameras are depicted, other examples contemplate the use of a single or additional (i.e., more than two) cameras. In one or more examples, the AR glasses 100 include any number of input sensors or peripheral devices in addition to the cameras 102. The front piece 138 is provided with an outward facing, forward-facing, or front or outer surface 120 that faces forward or away from the user when the AR glasses 100 are mounted on the face of the user, and an opposite inward-facing, rearward-facing, or rear or inner surface 108 that faces the face of the user when the AR glasses 100 are mounted on the face of the user. Such sensors can include inwardly-facing video sensors or digital imaging modules, such as cameras that can be mounted on or provided within the inner surface 108 of the front piece 138 or elsewhere on the frame 112 so as to be facing the user, and outwardly-facing video sensors or digital imaging modules such as the cameras 102 that can be mounted on or provided with the outer surface 120 of the front piece 138 or elsewhere on the frame 112 so as to be facing away from the user.

Such sensors, peripheral devices or peripherals can additionally include biometric sensors, ambient condition sensors, light sensors, temperature sensors, location sensors, Power Monitors, or any other such sensors. In one or more implementations, the AR glasses 100 include a track pad 140 or other touch or sensory input device to receive navigational commands from the user. One or more track pads 140 may be provided at convenient locations for user interaction on one or both of the track pad 140 and the temple piece 106.

In some examples, a PCB of the computer 132 includes a flexible section 146. In some examples, the flexible section 146 is located at or adjacent to the folding hinge 144. More specifically, the flexible section 146 may be located in a region either side of or crossing the (or each) folding hinge 144. The flexible section 146 adjacent a folding hinge 144 may undergo a degree of bending, flexing, or movement when the left and right arms 104 and 106 of the AR glasses 100 are opened and closed, for example. In some examples, the controlled hyperextension ability of the hyperextension mechanism 222 protects the folding hinge 144 and the flexible section 146 of the AR glasses 100 from damage, while allowing a managed hyperextension to address some of the negative viewing problems discussed further above.

FIG. 3B illustrates a hinge apparatus 220 according to some examples. The hinge apparatus 220 includes a first hinge member 206 and a second hinge member 208 (shown alone in FIG. 3A) rotatably coupled to the first hinge member 206 to allow rotation of the second hinge member 208 relative to the first hinge member 206 through a normal or permitted degree of rotation. A normal or permitted degree of rotation can also be called a rotation zone such as the example arm rotation zone 216 of FIG. 2B.

In some examples, the first hinge member 206 is rotatably coupled to the second hinge member 208 at an arm rotation axis 210 defined by a pair of tubular bosses 324 carried by the second hinge member 208. An enlarged view of the second hinge member 208 is shown in FIG. 3A. In FIG. 3C, a respective one of a pair of pins 328 is shown securing the first hinge member 206 rotatably to each tubular boss 324 of the second hinge member 208.

In some examples, the first hinge member 206 comprises installation portions including one or more alignment tabs 332 and screws 336 to secure the first hinge member 206 (and thereby the hinge apparatus 220) to a support arm 202 in the manner shown in FIG. 3D, for example. Other alignment and securing features are possible. In some examples, the second hinge member 208 also comprises installation portions including one or more securement tabs 338 and alignment holes 340 to secure the second hinge member 208 to an end of an arm of the AR glasses 100.

The hinge apparatus 220 thus includes in some examples integrated installation portions for robust mechanical coupling to the augmented reality glasses. These portions may comprise pins, holes, wall alignments, fasteners, or similar fixtures. The first hinge member connects securely to a support arm or front frame piece via its installation portions. Meanwhile, the second hinge member couples firmly to a rotating temple piece. This arrangement of interlocking installation fixtures creates a backbone for rotation of the temple pieces relative to the frame. Specifically, the first installation portions on the first hinge member engage corresponding second installation portions on the AR glasses frame or housing. The resulting stable assembly can reliably withstand repeated adjustment of the temples over long-term use without loosening. The installation portions thereby provide a foundation for smooth and controlled rotation of the hinge apparatus 220 throughout a full product lifecycle. They allow firm integration into the AR glasses 100 to support dynamic motions enabling a customizable fit and optical alignment. The mounting provisions fix the hinge apparatus 220 as a capable rotational platform for AR experiences.

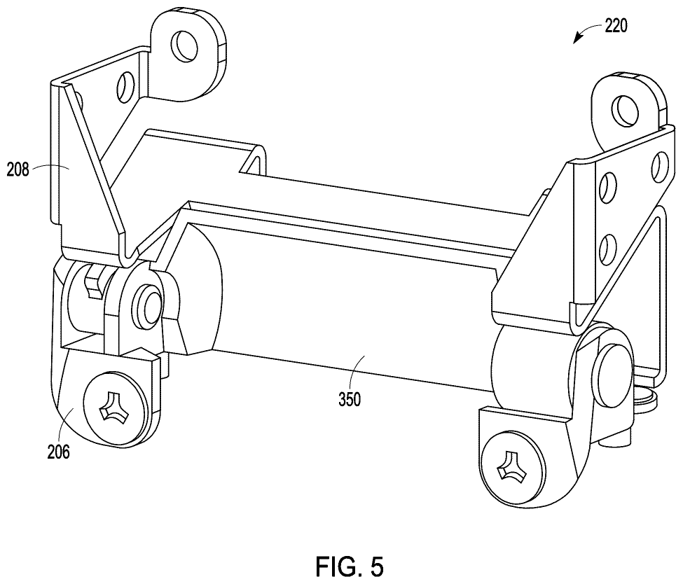

As mentioned above, in some examples, a hyperextension element or mechanism 222 is provided for the hinge apparatus 220. In the illustrated example of FIG. 4, the hyperextension mechanism 222 is formed integrally with the second hinge member 208, but other arrangements such as a separate fitting or integration are possible. The hyperextension mechanism 222 is configured to exert a continual clamping force between the first hinge member 206 and the second hinge member 208 in normal operation of the hinge apparatus 220, for example when the right arm 204 (or right arm or temple piece 106 of FIG. 1), and/or the left arm 206 (or left arm or temple piece 104 of FIG. 1) are rotated through the arm rotation zone 216. This normal rotational operation may occur for example between a first position in which the arms of the AR glasses 100 are folded inwardly to lie against the frame in a closed or non-use position of the AR glasses 100, and a second position in which the arms of the AR glasses 100 are folded outwardly into an open or in-use position of the AR glasses 100 in which the arms lie against the temples of a wearer to watch augmented content in the AR glasses 100, for example.

In some examples, the hyperextension mechanism 222 is further configured to exert a hyperextension clamping force between the first hinge member 206 and the second hinge member 208 when the first and second hinge members are over rotated with respect to one another, for example into a hyperextension zone such as the hyperextension zone 218 of FIG. 2B mentioned above. In some examples, the hyperextension mechanism 222 is engaged to exert the hyperextension clamping force upon the over rotation between the first hinge member and the second hinge member. The hyperextension clamping force seeks to return the hinge apparatus 220 to normal operation conditions (i.e., back to the arm rotation zone 216) while allowing a managed hyperextension to address some of the negative impacts on the optical components of the AR glasses 100 discussed above.

In some examples, the hyperextension element or mechanism 222 comprises a resilient or “spring” clip structure having a triangular or “delta” shape in a side or transverse view, as shown. Other shapes, such as a “C” shape, or “U” shape in a side or transverse view or cross section are possible. In some examples of the hinge apparatus, the arms of the clip structure, which exhibit a C or U shape in a side view, function as cantilevered elements. This cantilevered design can generate a clamping force when the hinge members are subjected to over-rotation into the hyperextension zone. As the first and second hinge members rotate beyond their normal range, the arms of the clip structure are forced to deflect, leveraging a cantilever principle to produce a restorative force. This force acts in opposition to the over-rotation, effectively clamping the hinge members together and resisting further hyperextension.

In some examples, the cantilevered arms of the clip structure are meticulously engineered to balance flexibility with rigidity. Upon entering the hyperextension zone, the inherent resilience of the clip arms allows them to flex while maintaining structural integrity. This flexibility ensures that the arms can absorb and dissipate the stresses of over-rotation, thereby generating a clamping force that is both responsive and controlled. The result is a hinge apparatus that offers enhanced protection against the potential for overextension, which can be helpful in the delicate context of augmented reality glasses where the alignment of optical components is critical.

In some examples, the cantilevered clip structure is designed to provide a variable clamping force. This variability can be helpful in some examples as it allows the hinge apparatus to adapt to different degrees of hyperextension, ensuring that the clamping force is proportionate to the extent of over-rotation. The clip arms, acting as cantilevered beams, exert an increasing clamping force as the angle of hyperextension grows, providing a progressive resistance that safeguards the AR glasses' structural and functional integrity.

In some examples, as illustrated for example, the clip structure holds the tubular bosses 324 and securement tabs 338 of the second hinge member 208 together without bias in a position as shown, i.e., touching or closely adjacent to each other, during normal operation or rotation of the arms of the AR glasses 100. In this version, no continual clamping force is generated, imposed, or exerted on the tubular bosses 324 and securement tabs 338 by the hyperextension mechanism 222. The inherent structural integrity of the resilient clip structure alone serves to provide a steady base or foundation for the arm rotation axis 210.

In some examples, the clip structure serves to bias the tubular bosses 324 and securement tabs 338 together even during normal operation or rotation of the arms. Here, the hyperextension mechanism 222 exerts a continual clamping force upon these elements and seeks to increase the rigidity of the hinge apparatus 220 and steadiness of the arm rotation axis 210. The continual clamping force acts to hold these elements together and increase stability of the overall hinge apparatus 220. The continual clamping force acts in the direction of arrows 344 and 346 in FIG. 3A in some examples. Other directions of bias or continual clamping force are possible.

In either arrangement (normally biased or unbiased), increasing hyperextension forces imposed on the arms of the AR glasses 100 can ultimately act, at a threshold level, to urge the tubular bosses 324 and the securement tabs 338 of the second hinge member 208 apart into a hyperextension zone. It will be recalled that the pins 328 secure the first hinge member 206 (attached to the support arm 202) to the second hinge member 208 (attached to the right arm 204) and transmit the imposed hyperextension forces to the tubular bosses 324 and drive them spatially away from their respective securement tabs 338 (i.e., drives them apart). This spatial movement deforms the clip structure of the hyperextension mechanism 222 and results in generation of an oppositely directed hyperextension clamping force. This oppositely directed hyperextension clamping force also acts in the direction of the arrows 344 and 346 of FIG. 3A.

In some examples, the clip structure of the hyperextension mechanism 222 is configurable to provide a variable hyperextension clamping force based on a change in a thickness or a width of the clip structure of the hyperextension mechanism 222. In some examples, the hyperextension clamping force exerted by the hyperextension mechanism 222 is dynamic or variable based on a degree of entry, by the first or second hinge member, into the hyperextension zone when the first and second hinge members are over rotated with respect to one another. For example, the further the tubular bosses 324 and securement tabs 338 are prized apart during a hyperextension event, the greater the deformation of the resilient clip structure resulting in a dynamically and proportionally increased restorative hyperextension clamping force generated by the hyperextension mechanism 222.

In some examples, the hyperextension mechanism 222 exerts a continual clamping force between the first and second hinge members during normal rotation of the temple pieces. This force increases rigidity of the rotating hinge structure. The rigid base better supports the arm rotation axis and integrated electronics passing through the hinge apparatus.

During a hyperextension event, the clamping force intensifies proportionally to the over rotation. For example, if a user over stretches the arms to accommodate an extra-large head size, the hinge members separate slightly. This deforms the resilient clip structure of the hyperextension mechanism, dynamically increasing its restorative clamping force.

The variable hyperextension clamping force thereby prevents uncontrolled or damaging separation of the hinge members. It allows managed flexibility while protecting sensitive optics and electronics integrated throughout the AR glasses. Specifically, unrestrained hyperextension could misalign waveguides or projectors in the frame, distorting the augmented display. Or over rotation may damage fragile data flexes routed from the temples. By engaging the hyperextension mechanism upon over rotation, the hinge apparatus avoids passing these excessive forces onto vulnerable display components. So the yielding yet restorative clamping force safeguards both the durable hinge structure itself, as well as sensitive electronics in the AR glasses that enable immersive user experiences. In some examples, the continual clamping force and/or the hyperextension clamping force generated by the hinge apparatus is in the range of 45 Newtons (N) to 350N, and in some examples in the range 45N to 85N.

With reference more particularly to FIG. 3C-FIG. 3D, it will be seen that the hinge apparatus 220 includes a part cylindrical shell structure 350 configured to seal or divide a first compartment from a second compartment during rotation between the first hinge member and the second hinge member. The part cylindrical shell structure 350 can be seen more clearly in these views. The function of the part cylindrical shell structure 350 is described in more detail in the figures below detailing aspects of how the hinge apparatus 220 is able to accommodate and protect electrical flex passing through the folding hinge 144 of the AR glasses 100 in some examples. In the illustrated example, the part cylindrical shell structure 350 is formed integrally with or on the first hinge member 206, but other separate or integral arrangements are possible.

With reference to FIG. 3D, in some examples, the hinge apparatus 220 includes a rotation limiter. Here, an arm of the clip structure comprises or acts as a rotation limiter 354 configured to restrict rotation of the first hinge member 206 relative to the second hinge member 208 to a specified angular range of a normal rotation zone before entry into the hyperextension zone. When rotated sufficiently (i.e., downward, or clockwise in the view of FIG. 3D) the rotation limiter 354 can act against an opposing surface 356 of the first hinge member 206 to limit or prevent further rotation of the first hinge member 206 with respect to the second hinge member 208. At this limit of rotational travel, the rotation limiter 354 engages or invokes operation of the hyperextension mechanism 222. In some examples, the rotation limiter 354 may comprise interacting protrusions and/or grooves located respectively on the first hinge member 206 and the second hinge member 208.

Reference is now made to FIG. 4 which shows a pictorial view of an example hinge apparatus 220 that includes a friction component 404. The friction component 404 is located, in the illustrated example, in one or both of the tubular bosses 324 but other locations and arrangements are possible. The friction component 404 is configured to provide rotational resistance between the first hinge member 206 and the second hinge member 208 member during normal operation, for example in the arm rotation zone 216. In some examples, the friction component 404 includes a C-shaped element in cross section as shown that is interposed between the pin 328 and the tubular boss 324 to generate friction and a resistive torque between these two elements, and consequently between the first hinge member 206 and the second hinge member 208. In some examples, a resistive torque of the friction component 404 is less than a resistive torque created by the hyperextension clamping force of the hyperextension mechanism 222.

The hinge apparatus 220 thus includes a friction component that provides rotational resistance between the first hinge member and the second hinge member. In some examples, this friction component 404 is carefully tuned or configured to create smooth rotation of the temple pieces of the AR glasses 100 with respect to the front frame 112. Specifically, the friction component 404 applies a resistive torque between the two hinge members. This resistive torque is less than that applied by the hyperextension mechanism in some examples. By keeping the friction component's resistive torque low, it avoids placing too much resistance on rotation of the temple pieces during normal use. This allows users to comfortably adjust the angle and position of the AR glasses.

At the same time, the presence of the friction component 404 prevents the temple pieces from swinging too freely or flapping in an uncontrolled fashion. Unimpeded swinging could lead to suboptimal alignment of AR display components or an uncomfortable wearing experience. The friction component 404 creates a smooth, controlled feel as users rotate the temples relative to the frames of the AR glasses 100. This improves overall usability and ergonomics of the AR glasses 100.

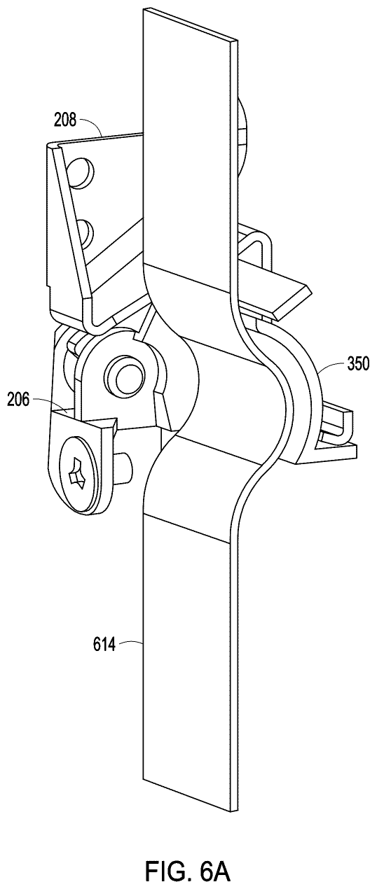

Reference is now made to FIG. 5. The hinge apparatus 220 is designed for integration into augmented reality glasses (such as the AR glasses 100) intended for lengthy wearable use. As such, minimizing size and weight of components can be helpful for ensuring user comfort during continuous wear. The first hinge member 206 and second hinge member 208 incorporate light-weight aluminum or plastic construction to reduce the mass contributed by these rotating components. In some examples, through the use of optimized materials and an efficient mechanical design, the entire hinge apparatus 220 may weigh in the range of only 1.4 to 10 grams approximately, in some examples. This light-weight construction helps to ensure the hinge apparatus 220 does not impart noticeable mass on the sides of the AR glasses 100.

While some present hyperextension mechanisms comprise a metal clip structure, other variants utilize polymers or composites to further minimize mass. Specifically, advanced plastics and carbon fiber compounds offer high strength-to-weight ratios. Replacing metals with lighter-weight polymers or carbon enable large reductions in density while retaining resilient force capabilities. For example, by using various composite layups and additive polymers, the clip could weigh 40% less than steel or aluminum while matching their durability. This significantly reduces the contribution of the hyperextension mechanism to overall hinge apparatus mass. Lighter hyperextension components would also allow redistributing freed weight budgets to additional sensors or projection electronics.

By using durable yet ultra-light metals or plastics, the hinge members avoid placing strain on vital head-worn sensory components in the AR glasses 100. The light-weight hinge apparatus construction thereby complements other ergonomic design elements to keep the AR glasses 100 comfortable during long-term wear. Users can enjoy rich AR experiences enabled by robust eye-tracking, scanning, and projection hardware integrated into the AR glasses, without discomfort arising from the hinges connecting the temple pieces and front frame.

The slim hinge apparatus profile also integrates cleanly into the arms of the AR glasses 100 without bulky protrusions that could cause pressure points on users' heads. The lightweight and compact hinge apparatus exemplifies wearability-focused design that bolsters all-day use of the AR glasses 100.

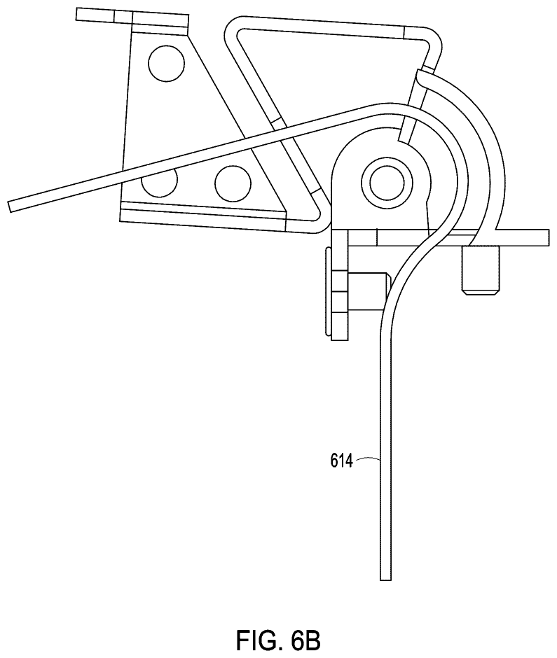

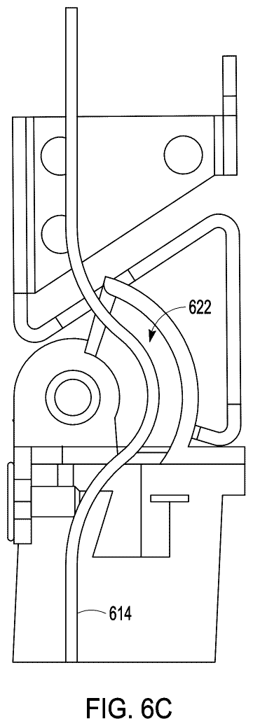

Reference is now made to FIG. 6A-FIG. 6C and FIG. 7A-FIG. 7B. As mentioned above, the hinge apparatus 220 includes a part cylindrical shell structure 350 configured to seal, enclose, or divide a first compartment from a second compartment during rotation between the first hinge member 206 and the second hinge member 208. This part cylindrical shell structure 350 is designed to allow passage of an electrical flex 614 connection between the two compartments. The electrical flex 614 may include or be constituted by one or more flexible printed circuits (FPCs) or flexible printed circuit boards (PCBs) in some examples. Other flexible electrical connections are possible.

In some examples, a multi-layered or multi-stranded electrical flex 614 electrically interconnects hardware components distributed across the AR glasses 100 frame and temple pieces. As mentioned above, these components may include batteries, cameras, sensors, processors, waveguides, projectors, and so forth that enable AR functionality. In some examples, the electrical flex 614 crosses through the hinge apparatus 220 when passing from the frame to the temples.

The part cylindrical shell structure 350 provides sufficient room and protection for the electrical flex 614 during opening/closing of the temples relative to the frame, for example as shown in the transition between FIG. 6B and FIG. 6C. Without the space 622, the electrical flex 614 might be pinched, crimped, or otherwise damaged causing failure of electrical continuity. Loss of the electrical flex 614 would disable core functions of the AR glasses. The part cylindrical shell structure 350 seals off, encloses, or divides and isolates the electrical flex 614 from the rotating first and second hinge members. This allows the electrical flex 614 to smoothly bend and route through the hinge apparatus 220 without risk of mechanical damage or electrical shorting. In some examples, reliable operation of the integrated AR electronics relies heavily on safe passage of the vital data electrical flex 614 via the hinge of the AR glasses 100, for example as shown in FIG. 7A-FIG. 7B.

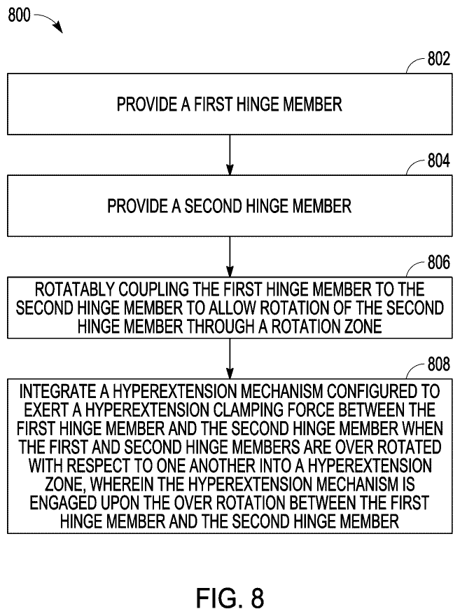

Some examples herein also include methods. With reference to FIG. 8, example operations in a method 800 of manufacturing a hinge apparatus are shown. In operation 802, the method 800 provides a first hinge member. In operation 804, the method 800 provides a second hinge member. In operation 806, the method 800 rotatably couples the first hinge member to the second hinge member to allow rotation of the second hinge member through a rotation zone. In operation 808, method 800 integrates a hyperextension mechanism configured to exert a hyperextension clamping force between the first hinge member and the second hinge member when the first and second hinge members are over rotated with respect to one another into a hyperextension zone, wherein the hyperextension mechanism is engaged upon the over rotation between the first hinge member and the second hinge member.

In some examples, the method 800 further comprises integrating a friction component configured to provide rotational resistance between the first hinge member and the second hinge member in the rotation zone.

### EXAMPLES

Some examples of this disclosure include the following:
Example 1. A hinge apparatus comprising a first hinge member; a second hinge member rotatably coupled to the first hinge member to allow rotation of the second hinge member through a rotation zone; and a hyperextension mechanism configured to exert a hyperextension clamping force between the first hinge member and the second hinge member when the first and second hinge members are over rotated with respect to one another into a hyperextension zone, wherein the hyperextension mechanism is engaged upon an over rotation between the first hinge member and the second hinge member.
Example 2. The hinge apparatus of example 1, wherein the hyperextension mechanism is formed integrally with the second hinge member.
Example 3. The hinge apparatus of example 1 or example 2, further comprising a friction component configured to provide rotational resistance between the first hinge member and the second hinge member in the rotation zone.
Example 4. The hinge apparatus of example 3, wherein a resistive torque of the friction component is less than a clamping force or resistive torque generated by the hyperextension mechanism.
Example 5. The hinge apparatus of any one of examples 1-4, wherein the hyperextension mechanism comprises a cantilevered or clip structure.
Example 6. The hinge apparatus of example 5, wherein the clip structure comprises at least one of a U-shape, a C-shape, or a triangular shape in a transverse view or a cross section.
Example 7. The hinge apparatus of any one of examples 1-6, wherein the hyperextension mechanism is configurable to provide variable hyperextension clamping force based on a change in a thickness or a width of the hyperextension mechanism.
Example 8. The hinge apparatus of any one of examples 1-7, wherein the first hinge member or the second hinge member comprises a part cylindrical shell structure configured to divide or enclose a first compartment from a second compartment during rotation between the first hinge member and the second hinge member.
Example 9. The hinge apparatus of example 8, wherein the part cylindrical shell structure is configured to allow passage of a flexible electrical connection between the first compartment and the second compartment.
Example 10. The hinge apparatus of any one of examples 1-9, further comprising first installation portions on the first hinge member configured to engage with corresponding second installation portions on a device, the first installation portions comprising one or more of a plurality of pins, holes, alignments of walls, or fasteners to attach the first hinge member to the device.
Example 11. The hinge apparatus of example 10, wherein the device includes augmented reality (AR) glasses.
Example 12. The hinge apparatus of any one of examples 1-11, wherein the hyperextension clamping force exerted by the hyperextension mechanism is variable based on a degree of entry, by the first or second hinge member, into the hyperextension zone when the first and second hinge members are over rotated with respect to one another.
Example 13. The hinge apparatus of any one of examples 1-12, wherein the first hinge member is coupled to a temple of AR glasses and the second hinge member is coupled to a front frame of the AR glasses.
Example 14. The hinge apparatus of any one of examples 1-13, further comprising a rotation limiter configured to restrict rotation of the first hinge member relative to the second hinge member to a specified angular range of the rotation zone before entry into the hyperextension zone.
Example 15. The hinge apparatus of example 14, wherein the rotation limiter comprises interacting protrusions and grooves located respectively on the first hinge member and the second hinge member.
Example 16. The hinge apparatus of any one of examples 1-15, wherein the first hinge member and the second hinge member each comprise, or are constituted by, a metal or plastic construction.
Example 17. The hinge apparatus of example 16, wherein the hinge apparatus has a weight in the range 1.4 to 10 grams.
Example 18. Augmented reality glasses comprising a frame with optical components configured to project augmented reality content; and at least one temple coupled to the frame via the hinge apparatus of example 1.
Example 19. A method of manufacturing a hinge apparatus, the method comprising providing a first hinge member; providing a second hinge member; rotatably coupling the first hinge member to the second hinge member to allow rotation of the second hinge member through a rotation zone; and integrating a hyperextension mechanism configured to exert a hyperextension clamping force between the first hinge member and the second hinge member when the first and second hinge members are over rotated with respect to one another into a hyperextension zone, wherein the hyperextension mechanism is engaged upon an over rotation between the first hinge member and the second hinge member.
Example 20. The method of example 19, further comprising integrating a friction component configured to provide rotational resistance between the first hinge member and the second hinge member in the rotation zone.

Although an example has been described with reference to specific example examples, it will be evident that various modifications and changes may be made to these examples without departing from the broader scope of the disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

1. A hinge apparatus comprising:
a first hinge member;
a second hinge member rotatably coupled to the first hinge member to allow rotation of the second hinge member through a rotation zone; and
a hyperextension mechanism configured to exert a hyperextension clamping force between the first hinge member and the second hinge member when the first and second hinge members are over rotated with respect to one another into a hyperextension zone, wherein the hyperextension mechanism is engaged upon an over rotation between the first hinge member and the second hinge member.

2. The hinge apparatus of claim 1, wherein the hyperextension mechanism is formed integrally with the second hinge member.

3. The hinge apparatus of claim 1, further comprising a friction component configured to provide rotational resistance between the first hinge member and the second hinge member in the rotation zone.

4. The hinge apparatus of claim 3, wherein a resistive torque of the friction component is less than a clamping force or resistive torque generated by the hyperextension mechanism.

5. The hinge apparatus of claim 1, wherein the hyperextension mechanism comprises a cantilevered or clip structure.

6. The hinge apparatus of claim 5, wherein the clip structure comprises at least one of a U-shape, a C-shape, or a triangular shape in a transverse view or a cross section.

7. The hinge apparatus of claim 1, wherein the hyperextension mechanism is configurable to provide variable hyperextension clamping force based on a change in a thickness or a width of the hyperextension mechanism.

8. The hinge apparatus of claim 1, wherein the first hinge member or the second hinge member comprises a part cylindrical shell structure configured to divide or enclose a first compartment from a second compartment during rotation between the first hinge member and the second hinge member.

9. The hinge apparatus of claim 8, wherein the part cylindrical shell structure is configured to allow passage of a flexible electrical connection between the first compartment and the second compartment.

10. The hinge apparatus of claim 1, further comprising first installation portions on the first hinge member configured to engage with corresponding second installation portions on a device, the first installation portions comprising one or more of a plurality of pins, holes, alignments of walls, or fasteners to attach the first hinge member to the device.

11. The hinge apparatus of claim 10, wherein the device includes augmented reality (AR) glasses.

12. The hinge apparatus of claim 1, wherein the hyperextension clamping force exerted by the hyperextension mechanism is variable based on a degree of entry, by the first or second hinge member, into the hyperextension zone when the first and second hinge members are over rotated with respect to one another.

13. The hinge apparatus of claim 1, wherein the first hinge member is coupled to a temple of AR glasses and the second hinge member is coupled to a front frame of the AR glasses.

14. The hinge apparatus of claim 1, further comprising a rotation limiter configured to restrict rotation of the first hinge member relative to the second hinge member to a specified angular range of the rotation zone before entry into the hyperextension zone.

15. The hinge apparatus of claim 14, wherein the rotation limiter comprises interacting protrusions and grooves located respectively on the first hinge member and the second hinge member.

16. The hinge apparatus of claim 1, wherein the first hinge member and the second hinge member each comprise, or are constituted by, a metal or plastic construction.

17. The hinge apparatus of claim 16, wherein the hinge apparatus has a weight in the range 1.4 to 10 grams.

18. Augmented reality glasses comprising:
a frame with optical components configured to project augmented reality content; and
at least one temple coupled to the frame via the hinge apparatus of claim 1.

19. A method of manufacturing a hinge apparatus, the method comprising:
providing a first hinge member;
providing a second hinge member;
rotatably coupling the first hinge member to the second hinge member to allow rotation of the second hinge member through a rotation zone; and
integrating a hyperextension mechanism configured to exert a hyperextension clamping force between the first hinge member and the second hinge member when the first and second hinge members are over rotated with respect to one another into a hyperextension zone, wherein the hyperextension mechanism is engaged upon an over rotation between the first hinge member and the second hinge member.

20. The method of claim 19, further comprising integrating a friction component configured to provide rotational resistance between the first hinge member and the second hinge member in the rotation zone.
